(19) United States
(12) Patent Application Publication
(10) Pub. No.: US 2004/0128256 A1
(43) Pub. Date: Jul. 1, 2004

(54) Remote location credit card transaction system with card present security system

(76) Inventors: Wayne F. Krouse, Houston, TX (US); Jessy Dhanjal, Iselin, NJ (US)

Correspondence Address: JAMES D. PETRUZZI, 4900 WOODWAY SUITE 745, HOUSTON, TX, 77056, US

(21) Appl. No.: 10/725,911

(22) Filed: Dec. 2, 2003

Related U.S. Application Data
(60) Provisional application No. 60/430,778, filed on Dec. 4, 2002.

(51) Int. Cl. G06F 17/60

(52) U.S. Cl. 705/65

(57) ABSTRACT

A home transaction bank card system and method is provided for cardholder/consumer purchasing using a remote location device having a browser program and connected to a public communications network to which merchant servers are connected and for payment using a standard bank issued card. The system includes a magnetic strip reader connected to the remote location device and having a point of sale (POS) identification code and configured to read customer account information from the card and to provide a signal to the communication device representing the POS identification and the customer account information and to provide authorization and verification as a card present transaction. The reader includes an electrically programmable memory by which the POS identification code is stored and periodically updated for registered cardholder communication devices. The EPM may be an electrically programmable memory, electronically erasable programmable memory, flash memory or other configurable or updateable memory storage device.

### CROSS REFERENCE TO RELATED APPLICATIONS

The present application is related to the following U.S. patent application: provisional patent application No. 60/430,778 titled REMOTE LOCATION CREDIT CARD PURCHASE SYSTEM TREATED AS A CARD PRESENT TRANSACTION, filed on Dec. 4, 2002, which is hereby incorporated by reference as if fully set forth herein.

### FIELD OF INVENTION

The present invention relates to Internet commerce using bank issued credit or debit cards to purchase products, whether services or goods. In particular, it relates to a system for cardholders to make purchases from merchants using standard bank issued magnetic stripe credit or debit cards in transactions that can be treated as a “Card Present” transactions by the card issuer and by others in the standard chain of processing for bank issued credit card purchases when the cardholder is in a remote location from the merchant. As used in this application a remote location is a physical location different from the physical location of the merchant and the transaction is processed over an open network using cardholder authentication.

### BACKGROUND OF THE INVENTION

In the credit card industry at this time, transactions are divided into primarily two types: “Card Present” and “Card Not Present.” Card Present transactions occur when a cardholder and the merchant are physically in the same location. The cardholder physically has possession of the card and typically signs a receipt of the services provided, although this is not always required for a “card present” transaction such as, for example, the use of the card at a gas station pump where no signature is required. The fact that the card is present and the merchant has the opportunity to verify the signature helps to reduce credit card fraud. If the card is later stolen, both the merchant and the customer are usually kept whole by the credit card company. If a chargeback is received, the merchant usually can provide proof that the customer made the purchase by having the signed receipt as evidence. Due to the low rate of fraud in this scenario, the credit card associations are able to give these types of merchants a lower discount rate per transaction. The discount rate is a combination of the credit card issuing bank rate and the merchant account provider rate. The second type of transaction is “Card Not Present” transactions. In this scenario, transactions occur when a cardholder and the merchant are not physically in the same location. A good example of these are purchases made over the internet. The merchant cannot verify the cardholder's physical possession of the card. The fact that the card is not present and the merchant cannot verify the cardholder or the signature by other forms of identification allows a much higher rate of credit card fraud to occur. If the charge is disputed in this case, the credit card company will reimburse the cardholder and the merchant is left unprotected pending an investigation. Since the merchant has no physical proof of the cardholder's identity, in more cases than not, the merchant will have to absorb the costs, the product or service that was provided and any additional shipping and handling fees. The merchant is fined a charge back fee. Due to the high rate of fraud in this scenario, the credit card associations charge merchants a significantly higher discount rate per transaction. In extreme cases of high credit card charge back rates, merchants can have their ability to accept credit card charges in a “card not present” scenario revoked by the closing down of their merchant account. Additionally, it is almost impossible for merchants to successfully dispute a charge back claim in the “card not present” scenario. Merchants (especially smaller merchants who represent more than 80% of online merchants) rarely have the time, resources or expertise to file a criminal complaint or conduct their own investigation.

### SUMMARY OF THE INVENTION

An aspect of the present invention is to provide a third scenario for online credit card transactions in which the merchant and the cardholder are physically in different locations whereby the cardholder initiates a “Card Present” transaction by swiping the credit card in a special remote location version of a point of sale (“POS”) card reader device which verifies the cardholder identity by use of a cardholder authentication password. The combination of card swipe, cardholder account information contained on the card, the order and the point of sale (POS) characteristic, i.e the transaction word or POS identifier, all together serve to identify the transaction as a “Card Present” transaction. The combination of “Card Present” card swipe and cardholder authentication initiated by the cardholder will be of significant advantage over other systems for remote location purchases using credit cards. For example, the new system will reduce charge backs for merchants, thereby reducing manpower, hardware and time to process charge backs for merchants, it will reduce charge backs for acquiring institutions, thereby reducing manpower, hardware and time to process charge backs for acquiring institutions, and it will reduce charge backs for card issuers (banks that issue credit cards), thereby reducing manpower hardware and time to process charge backs for the card issuers. It will be understood that the biggest differential in transaction cost is found in credit cards, yet a differential might also be found for debit cards and the invention could be applied to debit cards and stored value cards as well.

Another aspect of the present invention is to provide a security coding system that is combined with a remote point of sale terminal comprising a card reader connected to a home communication device using system implementing software and an electronically programmable memory chip (“EPM”) in the card reader terminal or other input device. The EPM may take the form of a erasable programmable read only memory (“EPROM”), electronically erasable programmable read only memory (“EEPROM”) or flash memory, or any of a variety of storage devices capable of receiving and storing new information on a repeated basis. When the computer is first registered via the internet, the electronic programmable memory is read and registered to the cardholder/consumer. In this manner, the keyboard is “tied” to that cardholder/consumer. On an intermittent basis, the EPM word is changed by coder generator servers. This unique identifier can be changed on a daily, hourly or shorter basis. In this manner, the EPM can not be compromised by hackers or a de-encryption algorithm before a new EPM word is loaded in to the cardholder's device. In order for a cardholder to make a successful “Card Present” transaction, the EPM word on the cardholder's device must match the EPM word registered to that cardholder on the code generator. This EPM word will be passed in the transaction word at the time of card swipe by the cardholder. The cardholder shops at the merchant's “storefront” for goods or services via a public computer network such as the Internet without physically being in the same location as the merchant. Upon locating the desired products at a merchant's website the cardholder loads a virtual shopping cart with selected products and then “swipes” a standard credit or debit card issued to the cardholder by an issuing bank when ready to check out and pay for goods or services. The special remote location point of sale (“POS”) card reader device reads the magnetic stripe of a currently existing issued bank issued card. In connection with the card swipe, a unique frequently changed POS characteristic code for the card reader terminal is uniquely provided by the EPM. This POS characteristic code is provided by a code generator server that programs the EPM in the card reader terminal. After a cardholder first registers the unique serial number of the memory on the cardholder's communication device, periodic access to the memory is provided directly to a card issuer via the public network to receive non-card account information such as name and address and to change the POS EPM code only for authorized cardholders.

At the time of any desired purchase by the cardholder from a merchant website, the cardholder swipes the card through the special remote location card reader device. The card swipe provides the complete cardholder information directly from the card and to the merchant's server over the public network. The information is encrypted for a first level of security. The complete information includes the cardholder's bank issued card account number, account identifier, card expiration date, transaction total (cost of the selected products in the shopping cart), and the POS EPM code that has been updated, or is updated at the time of the transaction, with the appropriate “current” EPM ID that identifies the special remote location card reader terminal. The updated EPM ID can then be checked by the card issuer for being “current” with the transaction, thereby further verifying that a bank issued card is present at the time of the transaction, so that the transaction may be treated as a “Card Present” transaction by the card issuer and by all entities in the chain of card authorization and transaction settlement.

The combination of card swipe, cardholder account information, shopping cart order and the POS EPM ID updated to the then current coded configuration all together serve to identify the transaction as a “card present” transaction. There is no interposed trusted server or “wallet server” outside of the cardholder's own communication device where a cardholder's account and other personal information must be stored in electronic wallet memory for later access to complete an online transaction. The transaction information passes through this system for processing without every being stored which does not allow or the possibility for information theft. The cardholder need not acquire a special stored value card or a “smart card” of the type having an integrated circuit or electronic chip. The updating of the coded configuration for the EPM ID uses encryption and is provided only to authorized special remote location card reader terminals on an intermittent basis. The EPM ID or transaction word including the cardholder account information is encrypted and forwarded to merchant's server via the public network and then on through the public network to a card acquirer and then to the issuing bank.

Authentication of the cardholder's identity or right to use the card, if desired by the issuing bank, is also accomplished via encryption cardholder. For example, the cardholder may be prompted at the appropriate time during the transaction to enter the PIN or password for encryption and transmission to the issuing bank. Upon authentication, the transaction is of a type that can be considered by the issuing bank (and others in the transaction chain such as the acquirer) as one with a lower risk of error or fraud than typical phone or Internet transaction type of “card not present”. In such typical transactions, the cardholder's card account number, expiration date, and CVV number are provided without swiping the card through a card reader. Such prior typical transactions do not have any indication that the card is actually present as CVV numbers can be copied and distributed around the internet just as easily as credit card numbers and expiration dates. With the present inventive system the special remote location terminal not only provides a EPM code identifying the fact that the information is coming from a card reader terminal, but in the enhanced situation of this present invention the EPM code is one that is periodically updated to confirm that only the registered cardholder can make a transaction, specifically a “card present” transaction. Thus, the transaction may be treated as a “card present” transaction, just as if the cardholder were at a merchant's place of business with card in hand at the time of the purchase. Alternatively, to the extent that a card issuer is not as comfortable with this as a “card present” transaction, the transaction may still be as another type of transaction other than a “card not present.” This inventive system avoids the “card not present” types of transactions in which it is more difficult to prevent fraud and thus more expensive to process.

### BRIEF DESCRIPTION OF THE DRAWINGS

FIG. 1 is a schematic diagram of an embodiment of the system of the present invention.

FIG. 2 is a flow diagram of an embodiment of the system of the invention.

FIG. 3 is a flow diagram of the registration for a home card reader terminal for periodic updating of a security code terminal identifier for a remote location bank issued card system according to one aspect of the present invention.

FIG. 4 is a flow diagram of a home card present system with a security code system according to one aspect of the present invention

### DETAILED DESCRIPTION OF THE ILLUSTRATIVE EMBODIMENTS

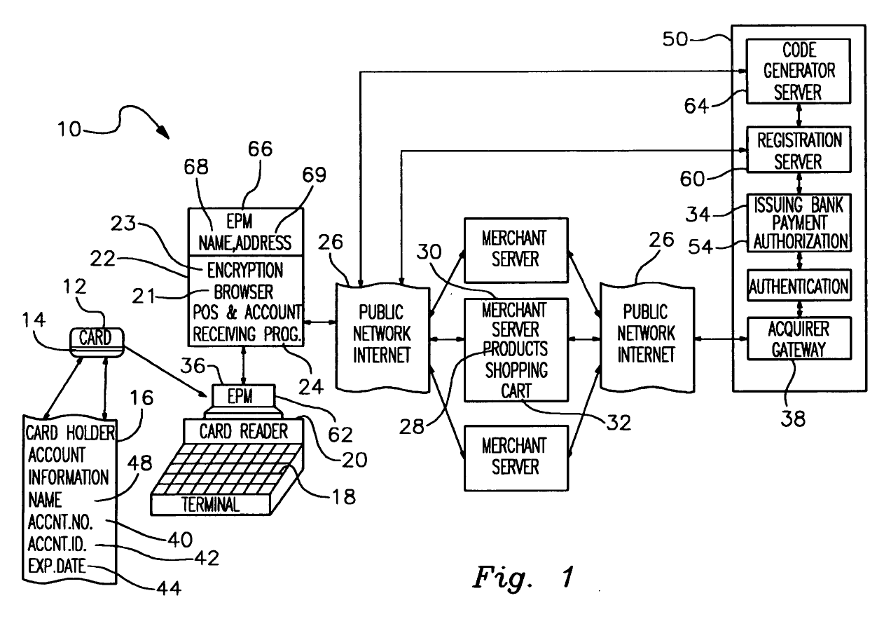

As depicted schematically in FIG. 1, the unique special remote location POS card reader device system 10 uses an issued credit or debit card 12 with a magnetic stripe 14 including card customer account information 16 and an electronically programmable memory (“EPM”) chip 36 in the card reader terminal 18. Cardholder information may include name, an account number, an account identification code or number, an expiration date and other pertinent information. System 10 provides a special remote location point of sale (POS) terminal 18 having a card reader 20 connected to a home communication device 22 using a system software program 24. Although a communication device may be a desktop personal computer (PC), it will be understood that other communication devices capable of network data communication might also be used in place of the PC, as for example, a laptop computer, a PDA or a mobile wireless device such as one using EMF as carrier waves, without deviating from certain aspects of the invention.

In operation, the card reader 20 reads the magnetic stripe 14 of the currently existing issued credit or debit card 12 by the card holder swiping the card at the home point of sale terminal 18 by moving the magnetic stripe of the card through the connected card reader 20. In connection with the card swipe, a unique frequently changed EPM ID 62 for the card reader 20 is uniquely provided at the terminal 18 as will be more fully discussed below. This frequently changed EPM ID 62 is provided by a code generator server 64 that will preferably be operated by the card issuer 34. The code generator server 64 programs EPM 36 in the card reader terminal 18 via the computer communication network 26 and the cardholder's communication device 22 connected to the network 26. According to this system a cardholder of the system would first register the home POS communication device for enhanced security service with a registration server 60, including providing the unique EPM data 66 on the cardholder's communication device 22 (or of another communications device as may be the case). Such data may be a unique serial number, name and address information or other information to identify the card reader. When EPM ID 62 of the EPM 36 is registered, periodic direct on-line access to the EPM 36 by the code generator server 64 is enabled. The enabled access allows the code generator server 64 to receive non-card account information such as registered cardholder name 68 and address 69 from the communication device or from the EPM via the public network 26 to confirm the registration of the EPM 36 with the registration server 60. Upon confirmed registration, the EPM ID 62 may be changed, so that the POS code 62 is changed periodically only for registered home cardholders authorized to use the enhanced security system.

A card holder cardholder shops for goods or services at the registered special remote location terminal, at home or at another location remote from the merchant, via a public computer network 26, such as the Internet, accessed using a browser program 21, such as Internet Explorer by Microsoft®, for navigating the network. Upon locating desired products 28 at a merchant's web site 30, the card holder loads a virtual shopping cart 32 with selected products 28 and then “swipes” the standard issued card 12 through the card reader 20 for reading both the cardholder's card account information 16 and also the EPM ID 62. Advantageously, the credit card 12, or debit card, is not of any special design. The bank issued card 12 is one that was previously issued to the cardholder by an issuing bank 34. The card swipe provides the complete card holder information 16 directly from the card 12, through the home card reader 20 and connected home communication device 22, to the merchant's server 30. Preferably the information 16 is encrypted with an encryption program 23, such as SSL, for a secure session. The complete information includes the card holder's name 48, bank issued card account number 40, account identifier 42, card expiration date 44 (all obtained from the card swipe), and also the transaction total (the total cost of the selected products in the shopping cart from communication device 22, as downloaded from the web site 30), and the point of sale (“POS”) EPM ID 62 that identifies the card reader 20 at terminal 18 (the “transaction word,” obtained from EPM 36 connected to the POS terminal 18 and card reader 20).

Uniquely, the invention provides additional security using a periodically changed EPM ID 62. The invention will use a POS code generator server 64 to produce a change code signal and forward it to the registered terminals of cardholders. A POS characteristic code in prior devices was one that was unique to each of the merchant's in-store POS devices that read a shopper's bank issued card via an in-store card swipe and identifies the transaction as being a “card present” transaction when the merchant and the cardholder are physically in the same location. In the present invention the POS characteristic code 62 will be stored in the EPM 36 at the special remote location card reader terminal 18. Further, advantageously for purposes of insuring the card is present when the transaction and card swipe are made from a home terminal, the EPM ID 62 will be replaced by a new code that is periodically received from the code generator server 64. The frequency at which the codes are received and changed can be set according to desired security and efficiency requirements for the system.

In one alternative embodiment, the periodically changed code 62 may be updated during any on-line remote location shopping session provided the EPM of the communication device 22 is registered. Thus, even in the event that the system is somehow disconnected from the network for any period longer than the frequency of the periodic update, the shopper will not be prevented from using the properly registered communication device 22.

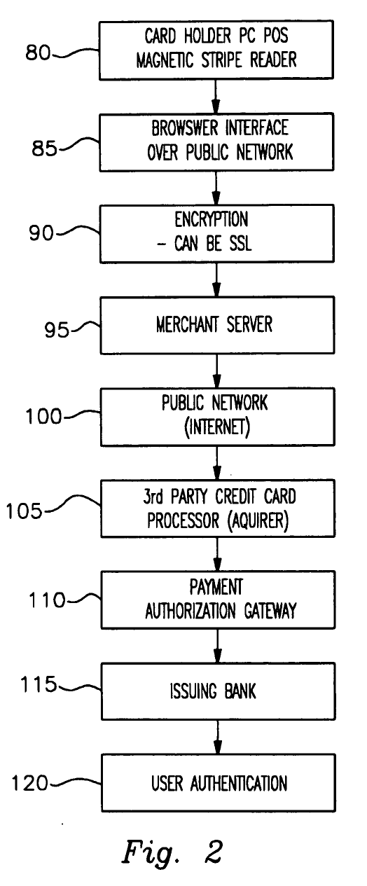

An understanding of certain features of the invention may be obtained with reference to FIG. 2, showing a flow diagram for the system and method for online commerce such as purchase of a service or a product from a merchant's online storefront, presence, website or the like. The system and method provide for a transaction that uniquely involves business where the cardholder and the merchant are at different places (implying that the physical credit card is not at the merchant's physical place of business), yet where card is present as indicated by the cardholder physically swiping the magnetic stripe of the credit card, or debit card, through a POS terminal integrated into the cardholder's personal computer in a home, office, or other remote location setting at a physical location different from the physical location of the merchant. As indicated at step 80 of FIG. 2, the POS remote location terminal is not the merchant's physical location, yet the presence of the card is established and the transaction may be treated as a card present transaction, or as another level of lower cost transaction with greater accuracy and assurances against fraud than the card not present internet transactions. This provides significant advantages and reduced processing than the card not present transactions where only the information printed on the card is reported to the merchant by telephone or typed into the communication device for communication to a merchant's server.

At step 85 the cardholder is provided with a browser program, such as Internet Explorer by Microsoft®, that is operated using a remote location communication device, such as a home personal computer (PC), a lap top computer, a handheld digital transmission device, a wireless device or another electronic communication device capable of connecting the cardholder to a public network and to allow the cardholder to browse or otherwise navigate the network. The connection to the Internet or world wide web may be through a telephone modem, through a DSL connection, through a cable connection, through wireless communication or other mechanism for communication with and through the public network. Software is provided to allow the browser program to accept cardholder information directly from the card swipe. By the use of the software and browser the cardholder is capable of populating a virtual shopping cart at a merchant server with such information directly from the magnetic stripe of the card and via the public network, as will be more fully explained below. The system eliminates the need to use stored value cards, smart cards with embedded chips, wallet servers or the like data storage devices external to the cardholder's own credit card and the magnetic stripe reader. Advantageously, the cardholder's personal information including the account number, expiration date and etc. will not be stored outside of the magnetic stripe on the cardholder's card. The EPM ID and the information read from the magnetic stripe on the card are passed directly from the physical card swipe trough the cardholder's communication device and to the web. This increases security and insures that the card will be present when the cardholder makes a purchase.

At step 90 the browser program is made active on a public network though an encryption program, such as, but not limited to SSL. The cardholder securely browses over a public network for goods or services to be purchased. By browsing, the cardholder effectively accesses one or more web sites provided by merchants through merchant servers. Upon selecting services or goods to be purchased from a particular merchant's web site, the cardholder enters a selection of services or goods, the card is swiped through the card reader and account information from the magnetic stripe on the cardholder's card and EPM ID information from the card swipe device are encrypted and up-loaded to the merchant's server. This loads the information directly into a virtual “shopping cart” at a merchant server. The information need not be stored in any intermediate location, so that the cardholder need not be concerned with the trustworthiness of a trusted server, a wallet server or other information storage device. The combination of the cardholder's credit card number, account identifier, card expiration date, transaction total and EPM ID (also called the transaction word) create a “card present” identifier. When this unique combination of features is further combined with a cardholder authentication program such as, but not limited to, Verified by Visa, the combination creates an online electronic commerce transaction for a magnetic stripe credit card that can be considered a “card present” transaction as well as being considered any other classification other than a “card not present” transaction. The Verified by VISA program involves the use of a password also known as a “personal identification number” (PIN) which is identified with the cardholder exclusively. It is the cardholders responsibility to keep this password/PIN a secret unto the cardholder. Once the card is activated by the Verified by VISA system, the card number and PIN will be recognized whenever the cardholder purchases at participating online stores. The cardholder enters his/her password or PIN in the Verified by Visa window, and the cardholder's identity will be verified, and the transaction will be completed. While Verified by Visa is a known proprietary authentication schema in the industry, other similar authentication schema by other card associations might also be used without departing from other aspects of the invention, such as, but not limited to, Master Card, AMEX, Discover, JCB, Diner's Club and Carte Blanche or a third party (non card association) authentication system. The additional transaction processing and risks of fraud or deception associated with a “card not present” transaction are eliminated or at least significantly reduced. Using encryption software between the cardholder and merchant, permits the information to be securely sent from the customer's browser at 85 across an open public network to the merchant server at 95.

The processing “upstream” from the merchant need not be modified from the currently existing processing for “card present” transactions. At step 100 the merchant further provides the transaction word, appropriately encrypted for security, over the public network and to a third party credit card processor (the acquirer at 105) and through the acquirer's payment gateway at 110 to the bank that issued the card to the cardholder (the issuing bank at 115). Before the transaction is approved, the cardholder is authenticated at 120 by the credit card association authentication program, such as Verified by Visa. The cardholder authentication may be performed according to other similar authentication schema by other card associations such as but not limited to AMEX, Discover, JCB, Diners Club and Carte Blanc or another third party (non-card association) authentication system. The present invention uniquely will work with any such authentication system. If the cardholder is authenticated, the transaction is settled with payment and appropriately smaller fees and charge backs than would be required for a “card not present” transaction. Thus the transaction is treated either as a “card present” transaction or as a transaction that is anything other than a high fee “card not present” transaction, because the inventive use of a remote location magnetic card reader to directly indicate the card is present and to transfer the customer account information directly from the card to the merchant server and up through the processing chain rather than through key input or by accessing other data storage devices, and combined with a cardholder authentication schema, eliminates or significantly reduces the characteristics that lend themselves to fraudulent transactions and increased processing expenses.

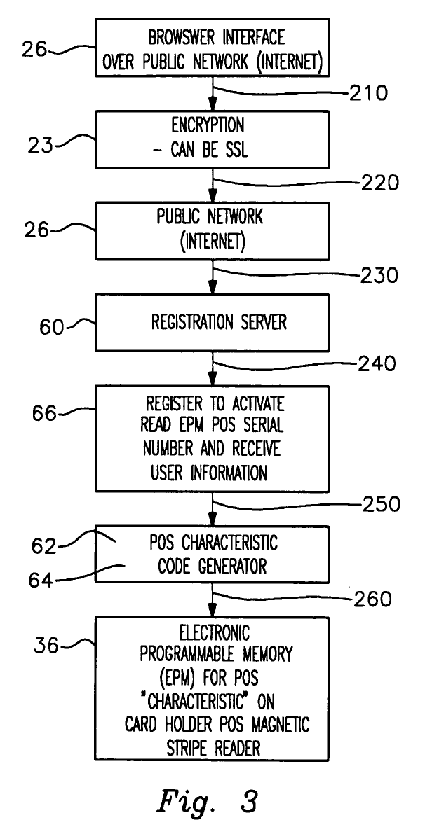

A greater understanding of certain features of the invention may be obtained with reference to FIG. 3, showing a flow diagram for registration of the cardholder terminal with the issuing bank for periodic updating of the terminal identification code according to certain aspects of the present invention. As shown in FIG. 3, in order to make use of the invention, the cardholder would first be required to register the serial number of the on-board electronically programmable memory (EPM) on their communication device or other electronic communication device, as by using a registration program or browser over a public network 26. When the inventive system is to be invoked on the cardholder's communication device, the cardholder will register from their program or browser at step 210 using an encryption program 23, for a securely encrypted communication session, at 220. The encrypted communication is sent across a public network 26 and ultimately, as shown at 230, communicates between the cardholder's communication device and a registration server 60. As depicted at 240, the registration server 60 then communicates directly, or through a code generator server 64, with the EPM 36 on the cardholder's POS communication device to read the unique identification serial number stored in the EPM 36 and to query the cardholder for cardholder information, that does not include bank issued card information 16 (shown in FIG. 1), in order to deliver the unique time dependent POS characteristic code 62 and to link, at 260, the current updated characteristic code 62 to an EPM 36 in the cardholder terminal 18 connected to the communication device 22 for which the registration server confirms only cardholder information (such as name 68 and address 69 from FIG. 1) that does not include the cardholder's bank issued card account information (see also FIG. 2). The cardholder information by which the characteristic code 62 is periodically up-dated might include, but need not be limited to, the name, mailing address and phone number of the cardholder. The registration server 60 should direct the EPM 36 to communicate with the POS characteristic code generator 64, at 260, to begin to receive the updated POS characteristic code 62. Again encryption is desirably used in all public network communications for the system to facilitate keeping the session secure.

In one embodiment, as long as the home terminal is properly registered to receive up-dated terminal characteristic codes, and the card holder is properly the holder of the card being used, the updated characteristic code properly indicates that the card is present when the card swipe is made. The transaction could be confirmed as a “card present” transaction even though the registered terminal is owned by someone other than the authorized card holder. In a preferred embodiment, the mailing address registered on the registration server is required to match the mailing address of the bank issued card when swiped in order for the inventive system to allow approval of a transaction. Advantageously, greater security is obtained by both confirming that the card is present by requiring the updated characteristic code and then also requiring the card holder and the registered communication device cardholder to be the same person.

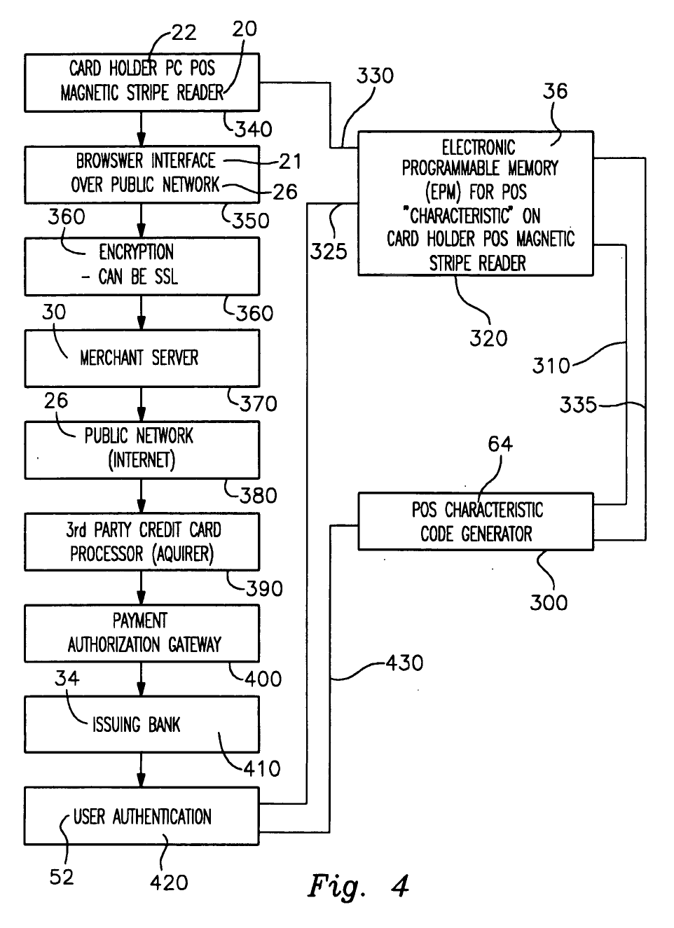

The operation or functioning of the inventive system is further shown in FIG. 4. Following registration, as discussed above in FIG. 3, the POS characteristic code generator 64 will generate at block 300 and send, at 310, POS codes to the EPM 36 on the POS device, as indicated at block 320 of FIG. 4. The updated POS code will replace the old POS code (characteristic) on the POS card reader 20 and terminal 18 that is connected to or integrated into the cardholder's communication device in a home or office setting that is not the same as the merchant's physical location, merchant's store or place of business. These POS characteristic codes are refreshed on a periodic frequency set in the software. The combination, of the cardholder's bank issued card number and account identifier, card expiration date, transaction total and the POS “characteristic” (also called the transaction word), creates a “card present” identifier. When combined with a cardholder authentication program such as but not limited to Verified by Visa, the combination allows an online electronic commerce transaction for a magnetic stripe bank issued card that can be considered a “card present” transaction as well be being considered any other classification other than “card not present.” When the cardholder swipes a bank issued card in the attached or integrated POS device, the EPM sends, at step 330, the POS characteristic code to the POS device to be combined, at block 340, with the bank issued card information read from the magnetic stripe 14 by the magnetic stripe reader 20. The cardholder's browser, at block 350, securely communicates, through an encryption program (such as, but not limited to SSL) at block 360, for a secure session with the merchant server, at block 370. The merchant's server then sends the information that is received from the customer's browser, across an open public network 26 at block 380 to the third party credit card processor, known as the Acquirer, at block 390.

The transaction word then goes from the acquirer through the acquirer's payment gateway, at block 400, to the cardholder's issuing bank 34 for approval, at block 410. Before the transaction is approved, the cardholder is authenticated by a credit card association authentication program, at block 420. The invention then verifies/authenticates the unique POS characteristic on the EPM by reading the POS characteristic code from the transaction word from the swipe of the cardholder's bank issued card magnetic stripe on the cardholder's POS device and comparing it, at 430 and 325, against the code sent, at 310, from the POS characteristic code generator 64 by requesting the EPM's POS characteristic code at 335. The non bank issued card cardholder information stored on the POS generator server 64 is requested and compared with the non-bank issued card cardholder information on record from the original registration process on the registration server. Preferably, in order for authorization 54 of the transaction to occur, both the POS characteristic and the unique cardholder information must both match with that on record from the POS characteristic code generator server and the registration server. If the POS characteristic code at the time of the card swipe matches the updated POS code when the transaction is being authorized, and the cardholder is authenticated, the transaction is settled as anything but a “card not present”, preferably as a “card present” transaction.

At any point in the future, when an internet (public network) connection is reestablished after it has been terminated, the POS will sense the enablement of the internet connection from the devices' operating system (OS) and the EPM 36 will query, at 335, the POS characteristic code generator 64 to begin receiving time dependent POS characteristic codes again at 310. These POS characteristic codes 62 are refreshed on a frequency set in the software.

The processing “upstream” from the merchant need not be modified from the currently existing processing for “card present” transactions. At step 335 the merchant further provides the transaction word, appropriately encrypted, at 360, for security, over the public network 26, at 380, and to a third party credit card processor (the acquirer), at 390, and through the acquirer's payment gateway, at 400, to the bank 34 that issued the card to the cardholder (the issuing bank), at 410. Before the transaction is approved, the cardholder is authenticated at 420 by the credit card association authentication program, such as Verified by Visa. The cardholder authentication may be performed according to other similar authentication schema by other card associations such as but not limited to AMEX, Discover, JCB, Diners Club and Carte Blanc or another third party (non-card association) authentication system. The present invention uniquely will work with any such authentication system. If the cardholder is authenticated, the transaction is settled with payment and appropriately smaller fees and charge backs than would be required for a “card not present” transaction. Thus the transaction is treated either as a “card present” transaction or as a transaction that is anything other than a high fee “card not present” transaction, because the inventive use of a home magnetic card reader to directly indicate the card is present and to transfer the customer account information directly from the card to the merchant server and up through the processing chain rather than through key input or by accessing other data storage devices. The system is uniquely combined or combinable with any of a number of cardholder authentication schema, such that it eliminates or significantly reduces the situations of bank issued card account information use that are known to lend themselves to fraudulent transactions and increased processing expenses.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A remote location transaction, bank issued card system for cardholder purchasing of services and goods selected for purchase using a remote location communication device having a browser program and connected to a public communications network to which merchant servers are connected and for payment using a standard bank issued card (a credit card or a debit card) of the type having cardholder account information recorded in a magnetic stripe on the bank issued card, the system comprising:
(a) a magnetic stripe reader connected to the remote location communication device and having a point of sale (POS) identification code and configured to read cardholder account information from the standard bank issued card and to provide an indication to the communication device representing the POS identification and the cardholder account information;
(b) a software program loaded on the communication device to receive the indication representing the POS and the account information from the magnetic card reader and to convey it along with selected services or goods through the browser program and the public network and to a merchant server on the network;
(c) an encryption program by which the information conveyed trough the public network is encrypted for secure transmission to the merchant server; and
(d) a bank issued card transaction completion system comprising an existing transaction processing system and connected to the merchant server for conveying the account information and POS identifier to the bank that issued the bank issued card to the cardholder and for authenticating the cardholder's use of the bank card thereby establishing that the bank issued card is present and settling the transaction on the basis of fee charges that are less than fee charges for card not present transactions.

2. The remote location transaction, bank issued card system of claim 1 wherein the bank issued card comprises a credit card.

3. The remote location transaction, bank issued card system of claim 1 wherein the bank issued card comprises a debit card.

4. The remote location transaction, bank issued card system of claim 1 wherein the card reader is integrally formed with a keyboard terminal through which the card reader is connected to the remote location communication device.

5. The remote location transaction, bank issued card system of claim 1 wherein the encryption program comprises an SSL program.

6. The remote location transaction, bank issued card system of claim 1 wherein the authentication system comprises a personal identification number (PIN) known to the cardholder and associated with the cardholder' account information by the issuing bank for authentication.

7. The remote location transaction, bank issued card system of claim 1 wherein the authentication system further comprises a Verified by Visa program.

8. The remote location transaction, bank issued card system of claim 1 wherein the authentication system treats the transaction as a card present transaction.

9. A bank issued card transaction system for cardholder purchasing of services and goods selected for purchase over a public network from a remote location at a physical location other than the location of a merchant providing the selected services or goods, comprising:
(a) a remote location communication device having a browser program and connected to a public communications network to which merchant servers are connected;
(b) a standard bank issued card provided to a cardholder by an issuing bank and of the type having customer account information recorded in a magnetic stripe on the bank issued card;
(c) a magnetic stripe reader connected to the remote location communication device and having a point of sale (POS) identification code and configured to read customer account information from the standard bank issued card and to provide a signal to the communication device representing the POS identification and the customer account information;
(d) a software program loaded on the communication device to receive the signal representing the POS and the account information from the magnetic card reader and to convey it along with selected services or goods through the browser program and the public network and to a merchant server on the network;
(e) an encryption program by which the information conveyed trough the public network is encrypted for secure transmission to the merchant server; and
(f) a bank issued card transaction completion system comprising an existing transaction processing system connected to the merchant server for conveying the account information and POS identifier to the bank that issued the bank card to the cardholder and for authenticating the cardholder's use of the bank card thereby establishing that the bank card is present and settling the transaction on the basis of fee charges that are less than fee charges for card not present transactions.

10. The bank issued card transaction system of claim 9 wherein the bank issued card comprises a credit card.

11. The bank issued card transaction system of claim 9 wherein the bank card comprises a debit card.

12. The bank issued card transaction system of claim 9 wherein the card reader integrally formed with a keyboard terminal through which the card reader is connected to the remote location communication device.

13. The bank issued card transaction system of claim 9 wherein the encryption program comprises an SSL program.

14. The bank issued card transaction system of claim 9 wherein the authentication system comprises a personal identification number (PIN) known to the cardholder and associated with the cardholder' account information by the issuing bank for authentication.

15. The bank issued card transaction system of claim 9 wherein the authentication system further comprises a Verified by Visa program.

16. A method of treating a remote location initiated bank issued card transaction, namely a transaction for cardholder purchasing of services and goods selected for purchase over a public network from a location away from a merchant providing the selected services or goods, as a transaction other than a card not present transaction, the method comprising the steps of:
(a) providing a remote location communication device having a browser program;
(b) connecting the remote location communication device to a public communications network to which merchant servers are connected;
(d) issuing a standard bank issued card to a cardholder from an issuing bank, the standard bank issued card of the type having customer account information recorded in a magnetic stripe on the bank issued card;
(e) providing a magnetic card reader with a point of sale (POS) identification code;
(f) connecting the magnetic stripe reader to the remote location communication device;
(g) configuring the magnetic card reader to read customer account information from the standard bank issued card and to provide an indication to the remote location communication device representing the POS identification and the customer account information;
(h) loading a software program onto the remote location communication device, said software capable of receiving the indication representing the POS identification and the account information from the magnetic card reader and capable of conveying the POS and account information through the browser program and the public network and to a merchant server on the network;
(i) using a browser program to selected and identify services or goods to be purchased from a given merchant having a merchant server on the public network;
(j) encrypting the POS identification and account information;
(k) conveying the encrypted POS identification and account information along with the identity of the selected services and goods to be purchased through the public network to the merchant server; and
(l) authenticating the cardholder's use of the bank card thereby establishing that the bank card is present by conveying the POS identification and account information from the merchant server to the issuing bank and thereby permitting settlement of the transaction on the basis of fee charges that are less than fee charges for card not present transactions.

17. A remote location bank card transaction system for cardholder purchasing of services and goods selected for purchase using a remote location communication device having a browser program and connected to a public communications network to which merchant servers are connected and for payment using a standard issued bank card (a credit card or a debit card) of the type having customer account information recorded in a magnetic stripe on the bank card, the system comprising:
(a) a magnetic stripe reader connected to the remote location communication device and having memory storage that receives periodically updated point of sale (POS) identification codes and configured to read customer account information from the standard bank issued card and to provide an indication to the communication device representing the updated POS identification code and the customer account information;
(b) a software program loaded on the communication device to receive the indication representing the POS and the account information from the magnetic card reader and to convey it along with selected services or goods through the browser program and the public network and to a merchant server on the network;
(c) an encryption program by which the information conveyed trough the public network is encrypted for secure transmission to the merchant server; and
(d) a bank card transaction completion system connected to the merchant server for conveying the account information and POS identifier to the bank that issued the bank card to the cardholder, for comparing the POS identification code at the time of the transaction to the current code at the time of the authorization, for authenticating the cardholder's use of the bank card thereby establishing that the bank card is present and settling the transaction on the basis of fee charges that are less than fee charges for card not present transactions.

18. The home transaction bank card system of claim 17 wherein the bank card is a credit card.

19. The home transaction bank card system of claim 17 wherein the bank card is a debit card.

20. The home transaction bank card system of claim 17 wherein the memory is electronically programmable.

21. The home transaction bank card system of claim 17 wherein the memory is flash memory.

22. The home transaction bank card system of claim 17 wherein the authentication system comprises a personal identification number (PIN) known to the cardholder and associated with the cardholder' account information by the issuing bank for authentication.

23. The home transaction bank card system of claim 17 wherein the authentication system further comprises a Verified by Visa program.

24. The home transaction bank card system of claim 17 wherein the authentication system treats the transaction as a card present transaction.

25. A bank card transaction system for cardholder purchasing of services and goods selected for purchase over a public network from a location away from a merchant providing the selected services or goods, comprising:
(a) a communication device having a browser program and connected to a public communications network to which merchant servers are connected;
(b) a standard bank card issued to a cardholder by an issuing bank and of the type having customer account information recorded in a magnetic stripe on the bank card;
(c) a magnetic stripe reader connected to the communication device and having a point of sale (POS) identification code and configured to read customer account information from the standard bank issued card and to provide an indication to the communication device representing the POS identification and the customer account information;
(d) a software program loaded on the communication device to receive the signal representing the POS and the account information from the magnetic card reader and to convey it along with selected services or goods through the browser program and the public network and to a merchant server on the network;
(e) an encryption program by which the information conveyed trough the public network is encrypted for secure transmission to the merchant server; and
(f) a bank card transaction completion system connected to the merchant server for conveying the account information and POS identifier to the bank that issued the bank card to the cardholder and for authenticating the cardholder's use of the bank card thereby establishing that the bank card is present and settling the transaction on the basis of fee charges that are less than fee charges for card not present transactions.

26. The home transaction bank card system of claim 25 wherein the bank card is a credit card.

27. The home transaction bank card system of claim 25 wherein the bank card is a debit card.

28. The bank card transaction system of claim 25 wherein the card reader integrally formed with a keyboard terminal through which the card reader is connected to the communication device.

29. The bank card transaction system of claim 25 wherein the encryption program comprises an SSL program.

30. The bank card transaction system of claim 25 wherein the authentication system comprises a personal identification number (PIN) known to the cardholder and associated with the cardholder' account information by the issuing bank for authentication.

31. The bank card transaction system of claim 25 wherein the authentication system further comprises a Verified by Visa program.

32 A method of treating a home initiate bank card transaction, namely a transaction for cardholder purchasing of services and goods selected for purchase over a public network from a location away from a merchant providing the selected services or goods, as a transaction other than a card not present transaction, the method comprising the steps of:
(a) providing a remote location communication device having a browser program;
(b) connecting the communication device to a public communications network to which merchant servers are connected;
(d) issuing a standard bank card issued to a cardholder by an issuing bank, the standard bank card of the type having customer account information recorded in a magnetic stripe on the bank card;
(e) providing a magnetic card reader with a point of sale (POS) identification code;
(f) connecting the magnetic stripe reader to the communication device;
(g) configuring the magnetic card reader to read customer account information from the standard bank issued card and to provide an indication to the communication device representing the POS identification and the customer account information;
(h) loading a software program onto the communication device, said software capable of receiving the signal representing the POS and the account information from the magnetic card reader and capable of conveying the POS and account information through the browser program and the public network and to a merchant server on the network;
(i) using a browser program to selected and identify services or goods to be purchased from a given merchant having a merchant server on the public network;
(j) encrypting the POS and account information;
(k) conveying the encrypted POS and account information along with the identity of the selected services and goods to be purchased through the public network to the merchant server; and
(l) authenticating the cardholder's use of the bank card thereby establishing that the bank card is present by conveying the account information and POS identifier from the merchant server to the issuing bank and thereby permitting settlement of the transaction on the basis of fee charges that are less than fee charges for card not present transactions.
